(19) United States
(12) Patent Application Publication
(10) Pub. No.: US 2010/0017569 A1
(43) Pub. Date: Jan. 21, 2010

(54) PCB INCLUDING MULTIPLE CHIPS SHARING AN OFF-CHIP MEMORY, A METHOD OF ACCESSING OFF-CHIP MEMORY AND A MCM UTILIZING FEWER OFF-CHIP MEMORIES THAN CHIPS

(75) Inventors: Michael S. Buonpane, Easton, PA (US); James D. Chlipala, Emmaus, PA (US); Richard P. Martin, Macungie, PA (US); Richard Muscavage, Gilbertsville, PA (US); Eric Wilcox, Allentown, PA (US)

Correspondence Address: HITT GAINES, PC;LSI Corporation, PO BOX 832570, RICHARDSON, TX, 75083, US

(73) Assignee: Agere Systems Inc., Allentown, PA (US)

(21) Appl. No.: 12/174,566

(22) Filed: Jul. 16, 2008

(51) Int. Cl. G06F 12/00

(52) U.S. Cl. 711/147; 711/E12.001

(57) ABSTRACT

A PCB having fewer off-chip memories than chips, a MCM, and a method of accessing an off-chip shared memory space. In one embodiment, the method includes: (1) generating a memory request at a first chip of the printed circuit board, (2) transforming the memory request to a shared memory request and (3) directing the shared memory request to an off-chip shared memory space indirectly coupled to the first chip via a second chip of the printed circuit board.

### TECHNICAL FIELD OF THE INVENTION

The present invention is directed, in general, to multiple chips, such as in multi-chip modules (MCMs) and, more specifically, to off-chip memory associated with the multiple chips.

### BACKGROUND OF THE INVENTION

A printed circuit board (PCB) may include multiple dice (chips). The multiple chips may be individually packaged (monolithic chips) or may be included in a MCM that incorporates multiple chips inside a single package. Each of the chips may have circuitry including digital signal processors (DSPs), busses, arbiters, etc. In order to increase the memory space available to the circuitry on the chips, off-chip memories are often used. Typically, each chip has an off-chip memory that is designated for the chip and connected directly to the chip through a memory interface on the chip. The memory interface may use various protocols to communicate with and control access to and from the off-chip memory. The off-chip memory for each chip may be a single memory chip or multiple memory chips connected together to form a memory network. The off-chip memory is often referred to as a memory space.

As noted above, a traditional off-chip memory approach would attach a separate memory space to each chip. For instance, if a MCM had four chips, four separate memory spaces would be used with a separate one of the four chips directly connected to a different one of the memory spaces. A chip could then connect to the designated memory space for that chip utilizing the memory interface to communicate therewith.

While using off-chip memory allows more memory space for the chips of, for example, an MCM, the additional area on a PCB required for the off-chip memories can be substantial. What is desirable in the art is a way to reduce the need for PCB area while maintaining the memory flexibility provided by off-chip memory spaces.

### SUMMARY OF THE INVENTION

To address the above-discussed deficiencies of the prior art, the present invention provides in one aspect a MCM. In one embodiment the MCM includes: (1) a first logic chip including a memory interface configured to couple the first logic chip to a shared memory space and (2) a second logic chip, coupled to the first logic chip, including a memory request interceptor configured to direct a memory request originating at the second logic chip to the shared memory space via the memory interface.

In another aspect, the present invention provides a method of accessing an off-chip shared memory space of a printed circuit board. In one embodiment, the method includes: (1) generating a memory request at a first chip of the printed circuit board, (2) transforming the memory request to a shared memory request and (3) directing the shared memory request to an off-chip shared memory space indirectly coupled to the first chip via a second chip of the printed circuit board.

In yet another aspect, the present invention provides a PCB. In one embodiment the PCB includes: (1) a multi-chip module having multiple logic chips requiring memory access and (2) at least one off-chip shared memory space directly-coupled to one of the multiple logic chips, wherein a total number of off-chip shared memory spaces coupled to the multi-chip module is fewer than a total number of the multiple logic chips.

In still yet another aspect, the present invention provides another embodiment of a PCB. In this embodiment the PCB includes: (1) multiple logic chips requiring memory access and (2) at least one off-chip shared memory space directly-coupled to one of the multiple logic chips, wherein a total number of off-chip shared memory spaces coupled to the multiple logic chips is fewer than a total number of the multiple logic chips.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a PCB constructed according to the principles of the present invention;

FIG. 2 illustrates a block diagram of another embodiment of a PCB constructed according to the principles of the present invention;

FIG. 3 illustrates a flow diagram of a method of accessing off-chip memory in a MCM carried out according to the principles of the present invention;

FIG. 4 illustrates a block diagram of an embodiment of a MCM having a hub-and-spoke architecture and configured to operate according to the principles of the present invention; and

FIG. 5 illustrates a block diagram of an embodiment of a PCB having monolithic logic chips and constructed according to the principles of the present invention.

### DETAILED DESCRIPTION

The present invention utilizes off-chip memory interfaces in only a subset of the chips in a MCM. Thus, the present invention provides a MCM using fewer off-chip memory spaces than the number of chips in the MCM that need to access memory. The invention allows software executing on any MCM chip to have access to an off-chip shared memory space in a manner that is transparent to a user. Thus, the same instructions can execute on any chip of the MCM, regardless if that particular chip has a direct physical interface to off-chip memory. To allow this transparency for the instructions, the invention provides a memory request interceptor that will “map” a memory request originating at a chip without a directly-coupled off-chip memory to an appropriate physical off-chip shared memory space.

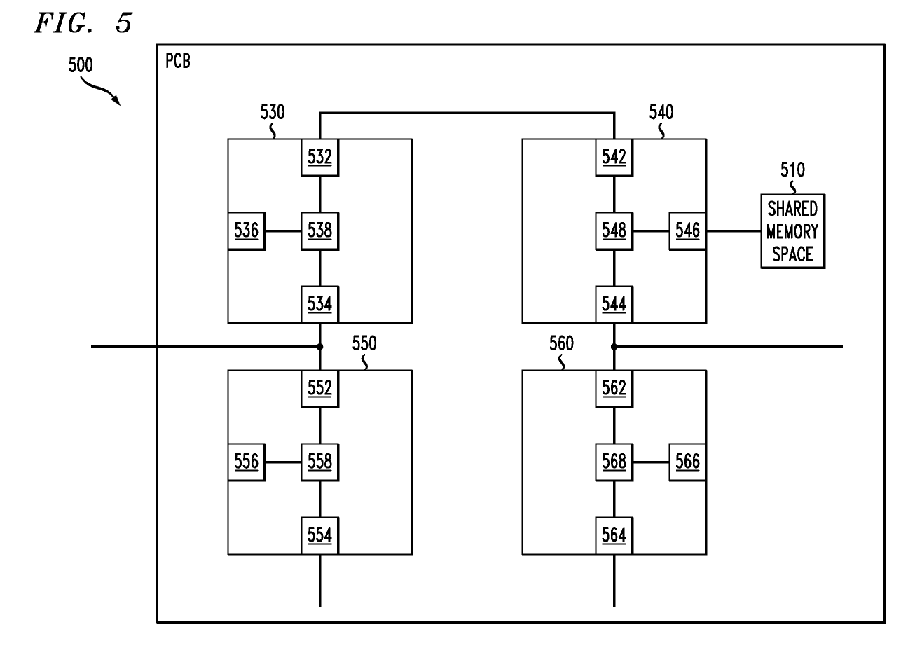

In addition to utilizing off-chip shared memory space for a MCM, the present invention also provides off-chip shared memory space for monolithic chips. For example, a PCB may include multiple chips with at least some of the chips utilizing the same off-chip shared memory space. FIG. 5 illustrates a PCB having four monolithic logic chips that utilize a single shared memory space.

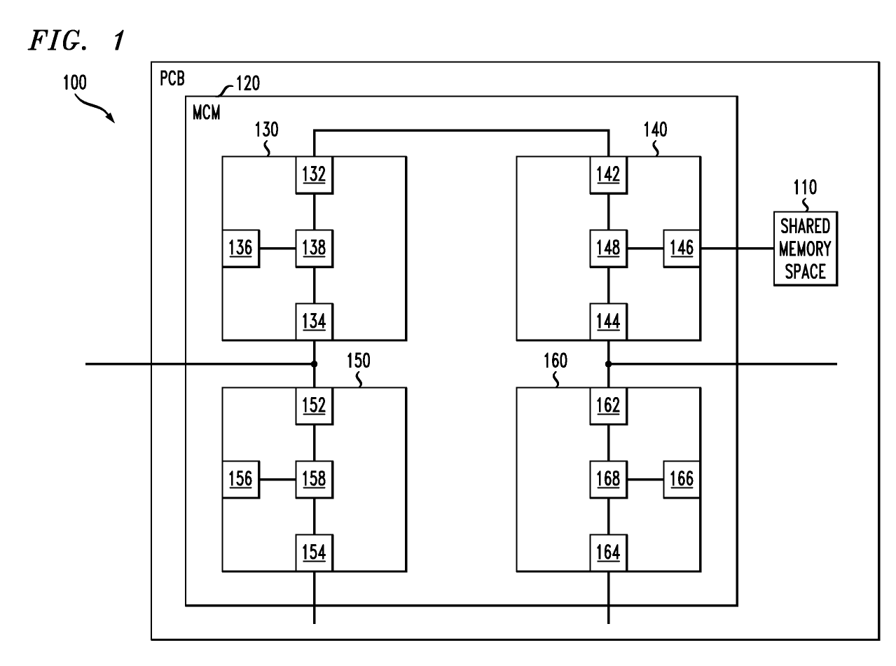

Referring initially to FIG. 1, illustrated is a block diagram of an embodiment of a PCB 100 constructed according to the principles of the present invention. The PCB 100 may be employed in electronic devices including, but not limited to, video games, cellular telephones, automobiles, etc. The PCB 100 includes a shared memory space 110 and a MCM 120. The PCB 100 may include additional components or interfaces that are typically included in a conventional PCB but are not illustrated or discussed herein.

The shared memory space 110 may be a conventional computer memory chip that is typically employed as an off-chip memory for a MCM. Instead of a single memory chip, the shared memory space 110 may be a network of memory chips. In some embodiments, the shared memory space 110 may be a random access memory (RAM). For example, the memory 110 may be a double-data-rate synchronous dynamic RAM (DDR), a double-data-rate two synchronous dynamic RAM (DDR2) or a double-data-rate three synchronous dynamic RAM (DDR3). In other embodiments, the shared memory space 110 may be a different type of memory couplable to a MCM.

The MCM 120 includes four chips designated 130, 140, 150 and 160. Each of the chips 130, 140, 150, 160, is a logic chip including logic circuitry to perform a function or functions. To perform at least some of the designated functions, each of the chips 130, 140, 150, 160, need to access a memory. Each of the chips 130, 140, 150, 160, collectively referred to as the logic chips, includes a first communication interface 132, 142, 152, 162, and a second communication interface 134, 144, 154, 164. The first and second communication interfaces are referred to collectively as the communication interfaces. Each of the logic chips also includes a memory interface designated 136, 146, 156, 166, respectively. Additionally, each of the logic chips include a memory request interceptor designated 138, 148, 158 and 168 (collectively referred to as memory request interceptors). The logic chips also include the necessary internal busses to provide interconnection between the circuitry, the multiple interfaces and the memory request interceptors. A portion of the internal busses are represented in the logic chips via an illustrated bus connecting the interfaces and the memory request interceptors.

The communication interfaces are configured to establish communication links for each of the logic chips. The communication links may be established with other logic chips of the MCM (i.e., inter-chip interface) or may be established for communicating off-MCM (i.e., off-MCM interface). Communication interfaces 132, 142, are examples of interfaces that provide inter-chip communication links. Communication interfaces 154 and 164 are examples of an off-MCM interface. Communication interfaces 154 and 164 not only allow external access to logic chips 150 and 160, respectively, but may also allow external access to each of the other logic chips through the connected inter-chip interfaces. Communication interfaces 134, 152, and 144, 162, are examples of interfaces that provide both inter-chip communication links and off-MCM communications links.

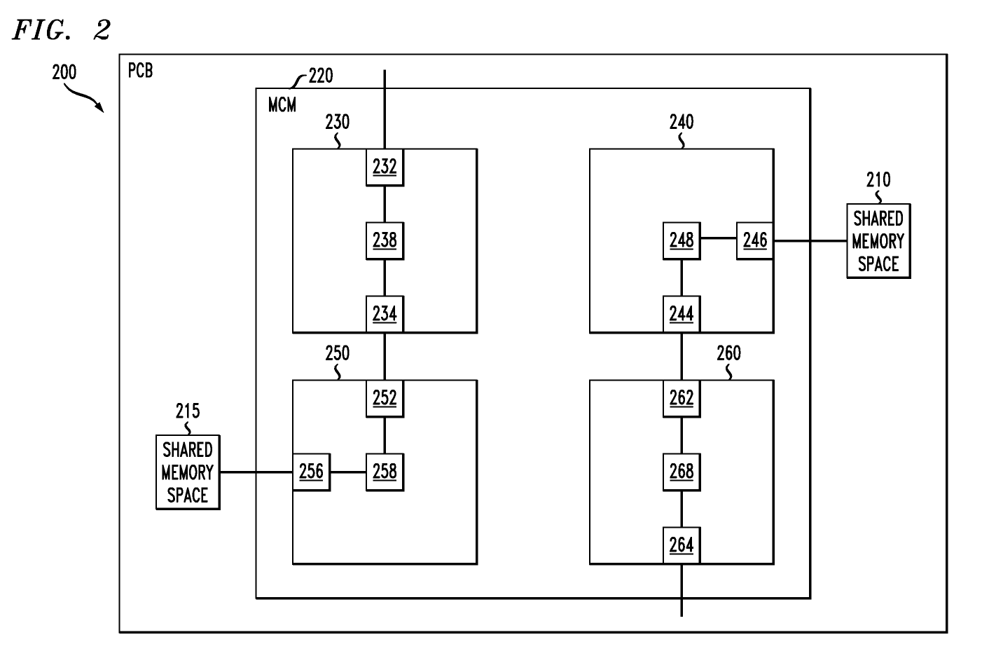

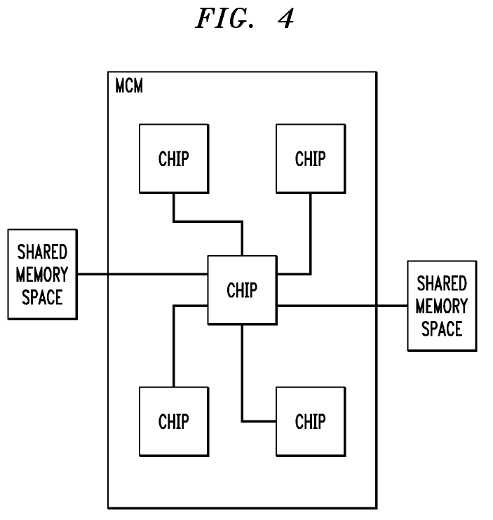

In other embodiments, the logic chips may include a different number of communication interfaces or a different arrangement of communication interfaces as those illustrated in FIG. 1. As illustrated in FIG. 2, in some embodiments a logic chip of a MCM may not include multiple communication interfaces. FIG. 4 provides an example of a different architecture for a MCM.

The communication interfaces may use various protocols in different embodiments to establish the communication links. A custom protocol or an industry standard protocol may be used. For example, the communication interfaces may use the standard PCI Express (PCIe) protocol to establish communication links. A PCIe interface can be organized in a variety of ways. In one embodiment, a PCIe communication interface may be configured to establish a PCIe connection for data and a separate system and control PCIe interface. These separate interfaces established by the PCIe communication interfaces could run at different speeds. For example, the communication interfaces 134 and 154 may provide a 10 gigabit per second data communication link and a 2.5 gigabit per second control and configuration communication link that also provides external access. Depending on, for example, cost and necessity, each of the communication links between the communication interfaces may include both a data and a control and configuration communication link.

The memory interfaces 136, 146, 156, 166, may be conventional memory controllers that are used to communicate with shared memory spaces. Unlike conventional MCMs, however, the memory interfaces 136, 156, 166, are not directly connected to an off-chip memory space and are not used to communicate with a memory space. Instead, memory interface 146 is used to communicate with a shared memory space, shared memory space 110, for each of the logic chips 130, 140, 150, 160, of the MCM 120. Memory interface 146 may use various protocols in different embodiments to communicate with the shared memory space 110. For example, the memory interface may be a DDR, DDR2 or DDR3 compliant controller. In some embodiments as illustrated in FIG. 2, a logic chip may not even include a memory interface. Thus, additional space can be saved on a chip along with a reduction of a PCB footprint.

The memory request interceptors are configured to direct a memory request associated with a logic chip to the shared memory space 110. The memory request interceptors may convert a memory request to a shared memory request that is then directed to the shared memory space 110. A memory request includes a memory address to access and may be generated by software operating on the logic circuitry of the logic chips. The memory address is for a memory space that is typically directly connected to the logic chip (i.e., is not connected via another chip). When a memory space is not directly connected to a logic chip (i.e., indirectly connected), as in the case of logic chips 130, 150 and 160, the memory request interceptors convert the memory address to a memory address of the shared memory space 110. The converted memory request, now a shared memory request, is then forwarded to the shared memory space 110.

The memory request interceptors may be, for example, implemented as dedicated hardware device. Additionally, the memory request interceptors may be implemented as a series of operating instructions that direct the operation of a computing device. In some embodiments, the memory request interceptors may be embodied employing a programmable interconnect fabric. For example, an ARM PL301 distributed by ARM Ltd., of Cambridge, UK, may be employed as at least part of a memory request interceptor. In these embodiments, each logic chip can be represented by ID bits that are included in a memory request. The memory request interceptors may map an appropriate space for each of the logic chips in the shared memory space 110. The memory interface 146 may be employed to map the appropriate areas of the shared memory space 110. This results in each of the logic chips having a designated space in the shared memory space 110.

When memory request interceptors receive a memory request, the memory request interceptors determine which of the logic chips originated the memory request by examining the included ID bits. If the originating chip is directly connected to the shared memory space 110, i.e., logic chip 140, then the memory request interceptor (memory request interceptor 148) forwards the memory request to the memory interface 146. If the originating chip is not directly connected to the shared memory space 110, e.g., logic chips 130, 150, 160, then the memory request interceptors 138, 158, 168, generate a shared memory request by converting the memory address to a shared memory address in the designated area for that particular chip in the shared memory space 110. The memory request interceptors then send the shared memory request to the shared memory space 110 employing the communication interfaces of the logic chips located therebetween. The memory request interceptors may use an address table to reconfigure memory requests to direct a memory request to a shared memory space instead of an address of a non-existent off-chip memory space.

For example, for logic chip 150, the memory request interceptor 158 converts a memory request originating in logic chip 150 (a native memory request) to a shared memory request and sends the shared memory request to the shared memory space 110 via the communication interfaces 152, 134, 132, 142, and memory interface 146. In this case, memory request interceptor 148 would perform as a conventional bus matrix when receiving the shared memory request and forward it to the memory interface 146. Memory request interceptor 138 would also perform similarly when receiving the shared memory request from logic chip 150.

The memory request interceptor 148 does not need to convert a native memory request to a shared memory request since the memory request is already in the proper form for a directly coupled off-chip memory. Thus, native memory requests for logic chip 140 are generated and forwarded to the shared memory space 110 as typically would occur in a logic chip having a designated off-chip memory space. The memory request interceptor 148 would then operate as a conventional bus matrix to forward a memory request originating from the logic chip 140 to the shared memory space 110.

In one embodiment, the shared memory space 110 may not have designated areas for particular logic chips. As such, any of the logic chips 130, 140, 150, 160, may have access to any address in the shared memory space 110. To coordinate writing and reading to the shared memory space 110, a memory manager may be used. The memory interface 146, for example, may include the needed intelligence to act as a memory manager and direct accessing of the shared memory space 110.

Turning now to FIG. 2, illustrated is a block diagram of another embodiment of a PCB 200 constructed according to the principles of the present invention. The PCB 200 includes a MCM 220. Additionally, unlike PCB 100, PCB 200 includes two shared memory spaces 210, and 215. As with the PCB 100 of FIG. 1, the PCB 200 may include additional components or interfaces that are typically included in a conventional PCB but are not illustrated or discussed herein.

The MCM 220 includes four chips designated 230, 240, 250 and 260. As with the MCM 120 in FIG. 1, each of the chips 230, 240, 250, 260, includes a memory request interceptor 238, 248, 258, 268, respectively. However, each of the chips 230, 240, 250, 260, does not include two communication interfaces or a memory interface. While chips 240 and 250 include a memory interface 246, 256, each of these chips 240, 250, include a single communication interface, 244 and 252, respectively. Chips 230 and 260 do include two communication interfaces 232, 234, and 262, 264, respectively, but do not include a memory interface. Absence of the interfaces creates space on these chips that may be used for additional logic circuitry.

Communication interfaces 232 and 264 provide off-MCM communication for logic chips 230, 250, and 260, 240, respectively. As noted previously, the communication links between communication interfaces 234, 252, and 244, 262, may include both an off-MCM communication link and an inter-chip communication link. The shared memory space 210 is used by the logic chips 240 and 260 while the shared memory space 215 is used by the logic chips 230 and 250. Memory interface 256 provides access to shared memory space 215 for both logic chips 230 and 250. Similarly, memory interface 246 provides access to shared memory space 210 for logic chips 240, 260. The shared memory spaces 210, 215, and the illustrated components of the logic chips 230, 240, 250, 260, may be configured and operate as the comparable components illustrated and discussed above in FIG. 1.

Though the architecture of FIG. 2 requires more area of PCB 200, the maximum latency for memory access is smaller for MCM 220 than MCM 120. For example, the maximum memory access latency for MCM 220 is a one chip distance (i.e., from logic chip 230 through logic chip 250 or from logic chip 260 through logic chip 240). For MCM 120, the maximum memory access latency is a two chip distance (i.e., from logic chip 150 through logic chips 130 and 140).

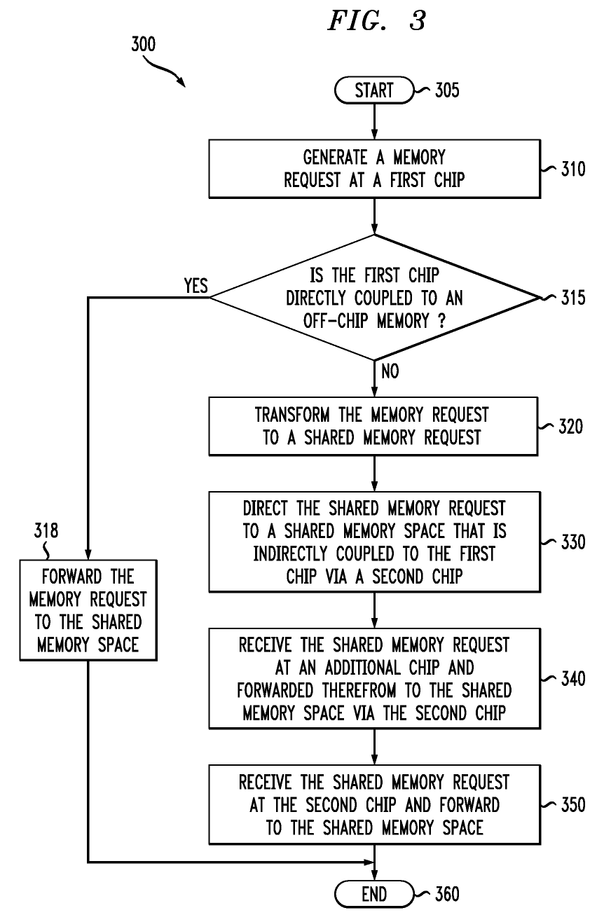

FIG. 3 illustrates a flow diagram of an embodiment of a method 300 of accessing off-chip memory carried out according to the principles of the present invention. The off-chip memory may be a shared memory space of a PCB that is shared between multiple chips of, for example, a MCM. The method 300 begins in a step 305.

After starting, a memory request is generated at a first chip of the PCM in a step 310. The memory request may be generated by software operating on circuitry of the first chip. After generating, a determination is made if the first chip is directly coupled to an off-chip memory in a decisional step 315. The determination may be made by a memory request interceptor of the first chip. The memory request interceptor may examine ID bits of the memory request to determine the identity of the first chip and, therefrom, if the originating chip has a directly-coupled off-chip memory. The memory request interceptor may include a table that relates the ID bits to particular chips and a corresponding off-chip memory status.

If the first chip is not directly-coupled to an off-chip memory, the memory request is transformed to a shared memory request in a step 320. In one embodiment, the memory request is transformed by converting a memory address included in the memory request to an address of a shared memory space that is in an area designated for the first chip. A memory request interceptor may be used to perform the transformation. Thus, a memory request interceptor may intercept a memory request and determine if the memory request needs to be converted to a shared memory request.

The shared memory request is then directed to a shared memory space that is indirectly coupled to the first chip via a second chip in a step 330. The shared memory space may be a designated off-chip memory for the second chip that is directly coupled thereto via a bus. The shared memory request may be directed to the shared memory space via inter-chip interfaces of the various chips of the PCB. A memory request interceptor of the first chip may perform the transforming and the directing.

After being directed to the shared memory space, the shared memory request is received at an additional chip of the PCB and forwarded therefrom to the shared memory space via the second chip in a step 340. The shared memory request may be received via communication links established by inter-chip interfaces. In some embodiments, multiple forwardings may occur depending on the architecture and the memory access latency.

The shared memory request is then received at the second chip in a step 350. The second chip may receive the shared memory request via an inter-chip interface. The shared memory request is then forwarded to the shared memory space in a step 360. The inter-chip interface may be coupled to a memory request interceptor that directs the shared memory request to a memory interface of the second chip. The memory interface is a memory controller that can send the shared memory request to the appropriate address in the shared memory space. After forwarding the shared memory request to the shared memory space, the method 300 ends in a step 360.

Returning now to decisional step 315, if the originating chip is directly coupled to an off-chip memory, then the memory request is forwarded to the off-chip memory in a step 318. The method 300 then continues to step 360 and ends.

The present invention provides a MCM that can reduce the overall footprint on a PCB by employing fewer off-chip memory spaces than logic chips of the MCM. Different embodiments of MCMs were illustrated and discussed herein. One skilled in the art will understand that a number of different inter-chip and off-chip communication interfaces can be employed to arrive at other embodiments having different arrangements than those disclosed herein. For example, a number of different off-chip memory interfaces could be included on a single chip. Different communication protocols may also be used. The networking architecture may also differ, e.g., hub-and-spoke as opposed to daisy chain.

For example, FIG. 4 illustrates a block diagram of an embodiment of a MCM having a hub-and-spoke architecture. The chips of the MCM in FIG. 4 include the necessary communication interfaces (not shown), for example, inter-chip interfaces and off-MCM interfaces, to operate according to the principles of the present invention. The center chip is directly coupled to two different shared memory spaces via different memory interfaces (not shown).

In addition to a MCM that can reduce the overall footprint of a PCB, the present invention also provides monolithic logic chips that utilize a shared memory space. Turning now to FIG. 5, illustrated is a block diagram of an embodiment of a PCB 500 having such monolithic logic chips and constructed according to the principles of the present invention. The PCB 500 includes a shared memory space 510 and monolithic logic chips 530, 540, 550 and 560, collectively referred to as the monolithic logic chips. The PCB 500 may be employed and configured similar to the PCB 100 of FIG. 1 except, instead of a MCM, the PCB 500 includes the monolithic logic chips. As with the PCB 100, the PCB 500 may include additional components or interfaces that are typically included in a conventional PCB but are not illustrated or discussed herein.

The shared memory space 510 may be configured as and operate as the shared memory space 110 of FIG. 1. As such, the shared memory space 510 may be a conventional computer memory chip or a memory network.

Each of the monolithic logic chips includes logic circuitry to perform a function or functions. To perform at least some of the designated functions, each of the monolithic logic chips need to access a memory. Each of the monolithic logic chips includes a first communication interface 532, 542, 552, 562, and a second communication interface 534, 544, 554, 564. Each of the logic chips also includes a memory interface designated 536, 546, 556, 566, respectively. Additionally, each of the logic chips include a memory request interceptor designated 538, 548, 558 and 568. The logic chips also include the necessary internal busses for interconnection therein.

The first and second communication interfaces, the memory interfaces 536, 546, 556, 566, and the memory request interceptors 538, 548, 558, 568, may be configured as and operate as the corresponding interfaces and memory request interceptors previously described herein. For example, memory interface 546 may be used to communicate with the shared memory space 510 for each of the monolithic logic chips. Additionally, the first and second communication interfaces in FIG. 5 may use the standard PCIe protocol to establish communication links as described herein with respect to FIGS. 1-2.

Although the present invention has been described in detail, those skilled in the art should understand that they can make various changes, substitutions and alterations herein without departing from the spirit and scope of the invention in its broadest form.

What is claimed is:

1. A multi-chip module, comprising:
a first logic chip including a memory interface configured to couple said first logic chip to a shared memory space; and
a second logic chip, coupled to said first logic chip, including a memory request interceptor configured to direct a memory request associated with said second logic chip to said shared memory space via said memory interface.

2. The multi-chip module as recited in claim 1 wherein said first logic chip further includes at least one inter-chip interface configured to couple said first logic chip to said second logic chip.

3. The multi-chip module as recited in claim 1 wherein said second logic chip further includes at least one inter-chip interface configured to coupled said second logic chip to said first logic chip.

4. The multi-chip module as recited in claim 1 further comprising a third logic chip coupled to said first logic chip and including a memory request interceptor configured to direct a memory request associated with said third logic chip to said shared memory space via said memory interface.

5. The multi-chip module as recited in claim 4 wherein said first logic chip further includes another inter-chip interface configured to couple said first logic chip to said third logic chip.

6. The multi-chip module as recited in claim 4 wherein said second logic chip further includes another inter-chip interface configured to couple said second logic chip to said third logic chip.

7. The multi-chip module as recited in claim 1 wherein said memory interface is directly coupled to said shared memory space.

8. A method of accessing an off-chip shared memory space of a printed circuit board, comprising:
generating a memory request at a first chip of said printed circuit board;
transforming said memory request to a shared memory request;
directing said shared memory request to an off-chip shared memory space indirectly coupled to said first chip via a second chip of said printed circuit board.

9. The method as recited in claim 8 wherein said transforming includes converting an address of said memory request to an address of said shared memory space.

10. The method as recited in claim 8 wherein said transforming and said directing are performed by a memory request interceptor of said chip.

11. The method as recited in claim 8 further comprising receiving said shared memory request at an additional chip of said printed circuit board and forwarding said received shared memory request therefrom to said shared memory space via said second chip.

12. The method as recited in claim 11 further comprising forwarding said shared memory request from multiple chips of said printed circuit board to said shared memory space.

13. The method as recited in claim 8 wherein said shared memory space is a designated off-chip memory for said second chip and is directly coupled thereto.

14. The method as recited in claim 8 further comprising determining if said first chip is directly coupled to an off-chip memory.

15. The method as recited in claim 8 wherein said first and second chips are chips of a multi-chip module of said printed circuit board.

16. A printed circuit board, comprising:
a multi-chip module having multiple logic chips requiring memory access; and
at least one off-chip shared memory space directly-coupled to one of said multiple logic chips, wherein a total number of off-chip shared memory spaces coupled to said multi-chip module is fewer than a total number of said multiple logic chips.

17. The printed circuit board as recited in claim 16 wherein said printed circuit board includes two off-chip shared memory spaces with each of said shared memory spaces directly-coupled to a different one of said multiple logic chips.

18. The printed circuit board as recited in claim 16 wherein at least two of said multiple logic chips are coupled together via a communication link established by an inter-chip communication interface.

19. The printed circuit board as recited in claim 16 wherein said at least one off-chip shared memory space is directly-coupled to said one of said multiple logic chips via a memory interface thereof.

20. The printed circuit board as recited in claim 16 wherein said multiple logic chips include a memory request interceptor.

21. The printed circuit board as recited in claim 16 wherein at least one of said multiple logic chips does not include a memory interface directly-coupled to said off-chip shared memory space.

22. A printed circuit board, comprising:
multiple logic chips requiring memory access; and
at least one off-chip shared memory space directly-coupled to one of said multiple logic chips, wherein a total number of off-chip shared memory spaces coupled to said multiple logic chips is fewer than a total number of said multiple logic chips.
